(19) United States
(12) Patent Application Publication
(10) Pub. No.: US 2009/0050480 A1
(43) Pub. Date: Feb. 26, 2009

(54) EXHAUST GAS SENSOR

(75) Inventors: Mario J. Arceneaux, Simpsonville, SC (US); Thomas Egner, Remseck (DE); James R. Waldrop, Belton, SC (US)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 11/844,118

(22) Filed: Aug. 23, 2007

(51) Int. Cl. G01N 27/26

(52) U.S. Cl. 204/424; 29/592.1

(57) ABSTRACT

An exhaust gas sensor that includes a sensor element having a cup-shaped member including an outer surface and an inner surface defining a cavity. The cup-shaped member further includes an exhaust electrode coupled to the outer surface and a reference electrode coupled to the inner surface. The exhaust gas sensor further includes a heating element located within the cavity and a heat conductive material within the cavity and between the inner surface of the cup-shaped member and the heating element to facilitate heat transfer from the heating element to the sensor element.

### BACKGROUND

The present invention relates to exhaust gas sensors, and more particularly, to exhaust gas sensors having heating elements.

Exhaust gas sensors are well known in the automotive industry for sensing the oxygen, carbon monoxide, or hydrocarbon content of the exhaust stream generated by internal combustion engines. Stoichiometric or “Nernst”-type oxygen sensors (a widely used type of exhaust gas sensor) measure the difference between the partial pressure of oxygen found in the exhaust gas and oxygen found in the atmosphere. By determining the amount of oxygen in the exhaust gas, the oxygen sensor enables the engine control unit (“ECU”) to adjust the air/fuel mixture and achieve optimal engine performance. Other types of exhaust gas sensors that operate based on different principles are also known and widely used in the automotive industry.

One type of exhaust gas sensor includes a heating element that is utilized to heat a sensing element of the exhaust gas sensor. Often, when the engine is started, the sensing element is at a temperature that is much lower than the temperature of the exhaust stream generated by the engine. Typically, it is desirable for the difference between the temperature of the sensing element and the temperature of the exhaust stream to be relatively small so that the sensor can accurately sense the contents of the exhaust stream. In some applications, the exhaust gas sensor is not activated until the temperature of the sensing element is within an acceptable range from the temperature of the exhaust stream. The amount of time needed to increase the temperature of the sensing element to the appropriate temperature is known as “light-off time.” Exhaust gas sensors that include heating elements can reduce the light-off time by increasing the temperature of the sensing element faster than using only the exhaust gas stream.

### SUMMARY

In one embodiment, the invention provides an exhaust gas sensor that includes a sensor element having a cup-shaped member including an outer surface and an inner surface defining a cavity. The cup-shaped member further includes an exhaust electrode coupled to the outer surface and a reference electrode coupled to the inner surface. The exhaust gas sensor further includes a heating element located within the cavity and a heat conductive material within the cavity and between the inner surface of the cup-shaped member and the heating element to facilitate heat transfer from the heating element to the sensor element.

In another embodiment the invention provides a method of assembling an exhaust gas sensor. The method includes providing a sensor element including a cup-shaped member having an outer surface and an inner surface defining a cavity. The sensor element further includes an exhaust electrode coupled to the outer surface of the cup-shaped member and a reference electrode coupled to the inner surface of the cup-shaped member. The method further includes at least partially filling the cavity with a heat conductive material and inserting a heating element into the cavity.

Other aspects of the invention will become apparent by consideration of the detailed description and accompanying drawings.

### BRIEF DESCRIPTION OF THE DRAWINGS

FIG. 1 is an exploded view of an exhaust gas sensor embodying the present invention.

FIG. 2 is a cross-sectional view of the exhaust gas sensor of FIG. 1 assembled.

FIG. 3 is a cross-sectional view of a portion of a heating element of the exhaust gas sensor of FIG. 1.

FIG. 4 is an alternative embodiment of the exhaust gas sensor of FIG. 1.

FIG. 5 is another alternative embodiment of the exhaust gas sensor of FIG. 1.

FIG. 6 is a cross-sectional view of the exhaust gas sensor of FIG. 5 assembled.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

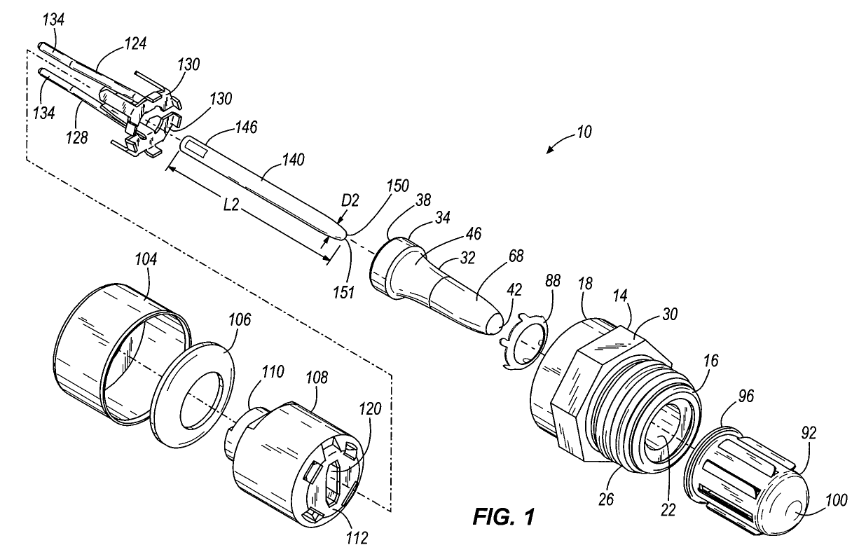

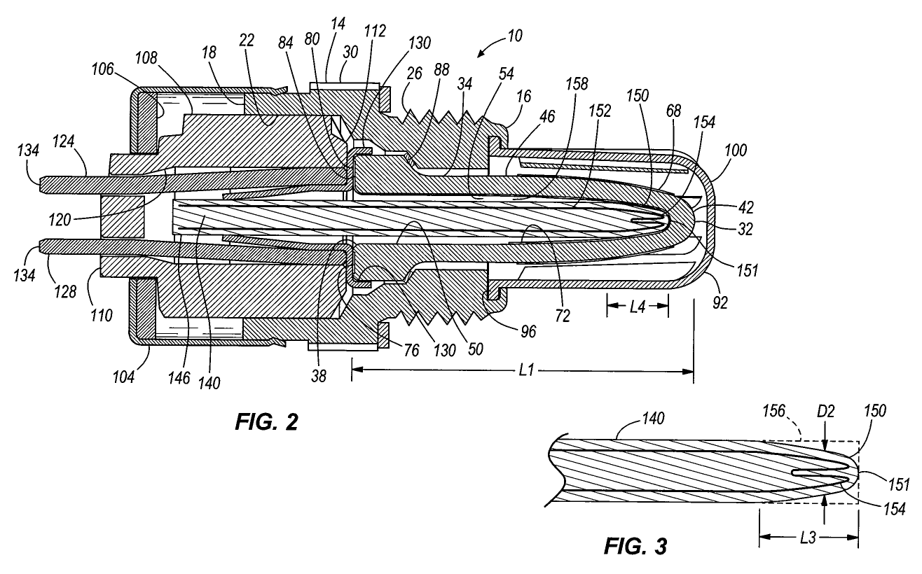

FIGS. 1 and 2 illustrate an exhaust gas sensor 10 for sensing the oxygen, carbon monoxide, hydrocarbon content, etc. of an exhaust stream generated by an internal combustion engine. The sensor 10 includes a generally cylindrical metallic housing 14 having a first end 16 and a second end 18. A bore 22 extends through the housing 14 from the first end 16 to the second end 18. In the illustrated construction, the housing 14 includes a fastener or threaded portion 26 and a nut or hex portion 30. The threaded portion 26 is configured to be received in a threaded aperture of an exhaust pipe or exhaust line or other component of the internal combustion engine. It should be understood that the engine can be used for automotive applications or non-automotive applications, such as motorcycles, snowmobiles, ATV's, lawnmowers, and the like.

The bore 22 of the housing 14 is sized to receive and support a sensor element 32. The sensor element 32 includes a ceramic cup-shaped member 34 having a length L1. The cup-shaped member 34 further includes an open end 38 that engages the housing 14 in the bore 22 and a rounded closed end 42 that extends out of and away from the end 16 of the housing 14. The cup-shaped member 34 further includes an outer surface 46 and an inner surface 50. The inner surface 50 defines a cavity 54. In the illustrated construction, the cup-shaped member 34 is the type commonly referred to as a thimble-type element and is made from materials such as stabilized ZrO₂, CaO—, Y₂O₃—, stabilized ZrO₂, Al₂O₃, Mg-spinel, and fosterite.

The sensor element 32 further includes an outer or exhaust electrode 68 and a reference electrode 72. The exhaust electrode 68 is coupled to the outer surface 46 of the cup-shaped member 34 and is in communication with the exhaust gas stream, as is understood by those skilled in the art. The exhaust electrode 68 is formed from a conductive and catalytically active material, such as platinum or other similar conductive and catalytically active materials. A lead portion 76 of the exhaust electrode 68 extends along the outer surface 46 of the member 34 toward the open end 38 of the member 34 to be in electrical engagement with the bore 22 of the housing 14, thereby grounding the exhaust electrode 68 through the housing 14.

The inner or reference electrode 72 is coupled to the inner surface 50 of the cup-shaped member 34 and is in communication with reference air, as is understood by those skilled in the art. The reference electrode 72 is formed from conductive and catalytically active material and the reference electrode 72 is positioned on the inner surface 50 of the cup-shaped member 34 within the cavity 54. A lead portion 80 of the reference electrode 72 extends along the inner surface 50 toward the open end 38 of the cup-shaped member 34 and out of the cavity 54 along an end surface 84 defining the open end 38 of the member 34. The reference electrode 72 communicates with reference air inside the cavity 54, as is also understood by those skilled in the art.

Referring to FIGS. 1 and 2, a seal ring 88 is positioned between the cup-shaped member 34 and the housing 14 to seal the cup-shaped member 34 to the housing 14.

The exhaust gas sensor 10 also includes a protection tube 92 that substantially surrounds and protects the second or closed end 42 of the cup-shaped member 34 that extends into the exhaust gas stream. The illustrated tube 92 is made of stainless steel or other heat resistant metal alloy and includes a open end 96 configured to be secured to the housing 14. A second, closed end 100 of the tube 92 substantially surrounds and protects the closed end 42 of the cup-shaped member 34. The tube 92 allows exhaust gas to enter therein for communication with the sensor element 32, yet protects the sensor element 32 from debris contained within the exhaust gas stream.

With continued reference to FIGS. 1 and 2, the sensor 10 further includes a sleeve 104 connected to the housing 14. An insulation bushing 108 is disposed within the sleeve 104 and includes a first end 110 and a second end 112 at least partially extending out of the sleeve 104. A disk spring 106 is disposed between the sleeve 104 and the bushing 108 to bias the bushing 108 toward the housing 14. In the illustrated construction, the bushing 108 is made of ceramic materials known as soapstone steatite or crypto-crystalline talc, and in some instances, can be made from materials having lower thermal conductivity and higher compressive strength, such as DOTHERM DT600M available from Industrial Engineering Products in Uxbridge, United Kingdom.

The bushing 108 includes an internal passageway 120 extending therethrough. The passageway 120 receives a signal contact plate assembly 124 and a ground contact plate assembly 128. The signal and ground contact plate assemblies 124 and 128 electrically connect the reference and the exhaust electrodes 72 and 68, respectively, to respective wire leads extending from the sensor 10 for electrical connection to an engine control unit (ECU).

The contact plate assemblies 124 and 128 are made from an electrically conductive material, such as metal. The bushing 108 thereby electrically isolates the contact plate assemblies 124 and 128 from the housing 14 and the sleeve 104.

As shown in FIGS. 1 and 2, each contact plate assembly 124 and 128 includes a contact plate 130 and a contact wire 134 that extends from the contact plate 130. In the illustrated construction, the contact wires 134 are separate components from the contact plates 130 and are mechanically coupled to the contact plates 130. A process such as welding, for example, may be used to mechanically couple the contact wires 134 with the respective contact plates 130.

With reference to the signal contact plate assembly 124 shown in FIGS. 1 and 2, the contact plate 130 engages the sensor element 32 to electrically contact the reference electrode 72. Likewise, with reference to the ground contact plate assembly 128, the contact plate 130 engages the sensor element 32 to electrically contact the exhaust electrode 68.

Referring to FIG. 1, the exhaust gas sensor 10 further includes a heating element or heater 140. As would be understood by one of skill in the art, the heating element 140 is operable to heat the sensor element 32. Also, as would be understood by one of skill in the art, heating the sensor element 32 during start-up of the engine reduces the light-off time or time until the sensor element 32 is operable to accurately sense the contents of the exhaust gas stream.

Referring to FIGS. 1 and 2, the heating element 140 is a generally cylindrical ceramic heating element having a length L2, a first end portion 146, and a tapered or rounded second end portion 150 that terminates at a distal end 151 of the heating element 140. The tapered second end portion 150 has a length L3 (FIG. 3). As will be discussed further below, the tapering or rounding of the second end portion 150 conforms substantially to the shape of the cavity 54 at the closed end 42 of the member 34. The heating element 140 further includes an embedded heating wire 152 (FIG. 2). The heating wire 152 includes meandering curves 154 (often referred to as the meander) adjacent the second end portion 150 of the heating element 140.

In the illustrated construction, the heating element 140 is cylindrical along about 90 percent of the length L2 of the heating element 140 and the second end portion 150 has an outer diameter D2 that decreases in a direction from the first end portion 146 toward the second end portion 150. In other words, the length L3 of the tapered second end portion 150 is approximately 10 percent of the total length L2 of the heating element 140. In other constructions, the length L3 of the tapered second end portion 150 is at least about 10 percent of the length L2 of the heating element 140. In yet other constructions, the length L3 of the tapered second end portion 150 is at least about 5 percent of the length L2 of the heating element 140. In other constructions, other variations and relative lengths are possible depending on the size of the heating element.

The dashed line 156 of FIG. 3 illustrates the outer boundary of a conventional cylindrical ceramic heating element, whereas the heating element 140 includes the tapered or rounded second end portion 150. The taper of the second end portion 150 of the heating element 140 can be formed using any suitable method. For example, in one construction, the tapered second end portion 150 can be formed by grinding a conventional cylindrical ceramic heating element. In other constructions, the tapered second end portion 150 can be integrally formed with the heating element 140, and in yet other constructions, the tapered second end portion 140 can be formed by machining and the like.

Referring to FIG. 2, the heating element 140 is positioned within the cavity 54 of the cup-shaped member 34 such that the second end portion 150 is located within the cavity 54 and the first end portion 146 is located outside of the cavity 54. As shown in FIG. 2, the tapered second end portion 150 of the heating element 140 is formed such that the second end portion 150 substantially conforms to the inner surface 50 of the cup-shaped member 34. Accordingly, the heating element 140 directly contacts the inner surface 50 of the sensor element 32 at the closed end 42 of the cup-shaped member 34. While the heating element 140 has been described as directly contacting the inner surface 50 of the sensor element 32, it should be understood that the heating element 140 and/or the inner surface 50 of the sensor element 32 can include coatings, films, surface features, etc., while still directly contacting each other.

The heating element 140 contacts the sensor element 32 along the inner surface 50 within the cavity 54 to define a contact length L4. In the illustrated construction, substantially the entire tapered second end portion 150 of the heating element 140 contacts the sensor element 32. Therefore, the contact length L4 is approximately equal to the length L3 of the tapered second end portion 150 of the heating element 140. As stated above, the length L3 of the tapered second end portion 150 is approximately 10 percent of the total length L2 of the heating element 140, and therefore, the second end portion 150 contacts the sensor element 32 along about 10 percent of the length L2 of the heating element 140. In other constructions, the length L3 of the tapered second end portion 150 is at least about 10 percent of the length L2 of the heating element 140, and therefore, the second end portion 150 contacts the sensor element 32 along at least about 10 percent of the length L2 of the heating element 140. In yet other constructions, the length L3 of the tapered second end portion 150 is at least about 5 percent of the length L2 of the heating element 140, and therefore, the second end portion 150 contacts the sensor element 32 along at least about 5 percent of the length L2 of the heating element 140. In other constructions, other variations and relative lengths are possible depending on the size of the heating element.

A contact ratio is defined as the contact length L4 divided by the length L1 of the cup-shaped member 34. In the illustrated construction, the contact ratio (L4/L1) is approximately 0.2. Accordingly, the heating element 140 contacts sensor element 32 along approximately 20 percent of the length L1 of the cup-shaped member 34 and such contact is more than mere point contact or line contact between the heating element and the sensor element. In other constructions, the contact ratio is greater than about 0.05, in yet other constructions, the contact ratio is greater than about 0.10, and in yet other constructions, the contact ratio is greater than about 0.15. In yet other embodiments, the contact ratio is less than about 0.50. As seen in FIG. 2, in the illustrated construction, the contact between the heating element 140 and the sensor element 32 extends beyond the distal end 151 of the heating element 140 and along the second end portion 150 of the heating element 140 toward the first end portion 146.

The heating element 140 contacts the sensor element 32 along only a portion of the sensor element 32. Therefore, an air gap 158 is formed between the heating element 140 and the sensor element 32 where the heating element 140 does not contact the sensor element 32. As would be understood by one of skill in the art, the air gap 158 facilitates the passage of reference air to the reference electrode 72.

The illustrated contact between the heating element 140 and the sensor element 32 along the contact length L4 increases heat transfer from the heating element 140 to the sensor element 32. The increased heat transfer reduces the amount of time needed to heat the sensing element 32 during start-up of the engine. The relative length of contact between the heating element 140 and the sensor element 32 can be varied to achieve optimal conduction from the heating element 140 to the sensor element 32 depending on the configuration of the heating element 140 and the sensor element 32. The contact between the second end portion 150 of the heating element 140 and the sensor element 32 also restricts lateral movement of the heating element 140 with respect to the sensor element 32 and reduces the possibility of damaging the heating element 140 due to sudden movements, shocks, or vibrations. Also, the tapered or rounded second end portion 150 of the heating element 140 reduces cracking, chipping, etc. at the end of the heating element 140 when the heating element 140 is inserted into the cavity 54 during assembly of the sensor 10. Furthermore, the tapered second end portion 150 of the heating element 140 positions the heating wire 152 and especially the meandering curves 154 closer to the exterior surface of the heating element 140, and therefore, closer to the sensor element 32 thereby increasing heat transfer to the sensor element 32.

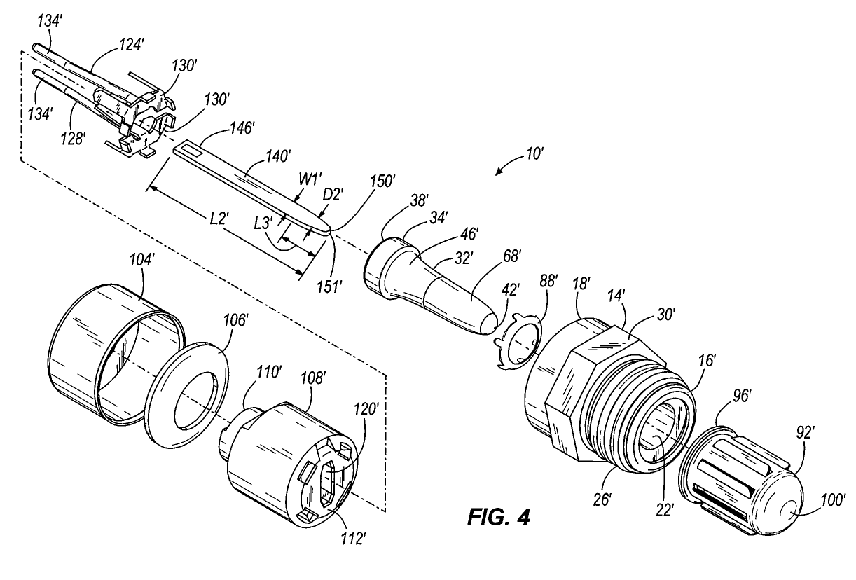

FIG. 4 illustrates an alternative construction of the exhaust gas sensor 10 of FIGS. 1-3. The exhaust gas sensor 10′ of FIG. 4 is substantially similar to the exhaust gas sensor 10 of FIGS. 1-3. Therefore, like components have been given the same reference number with the addition of a prime symbol and only the differences between the exhaust gas sensor 10 of FIGS. 1-3 and the exhaust gas sensor 10′ of FIG. 4 will be discussed in detail below.

The exhaust gas sensor 10′ includes a planar heating element 140′. The planar heating element 140′ includes the first end portion 146′ and the second end portion 150′ having the length L3′. The second end portion 150′ is tapered or rounded to conform to the inner surface 50′ (see FIG. 2) of the cup-shaped member 34′. In the illustrated construction, the second end portion 150′ has a width or an outer dimension D2′ that decreases in a direction from the first end portion 146′ toward the second end portion 150′. The lengths L1′, L2′, L3′ and the contact length between the heating element 140′ and the sensor element 32′ can have the same relationships as described above in reference to the sensor 10′. In other constructions, the relative lengths and dimensions can vary depending on the specific size of the heating element and/or sensor element.

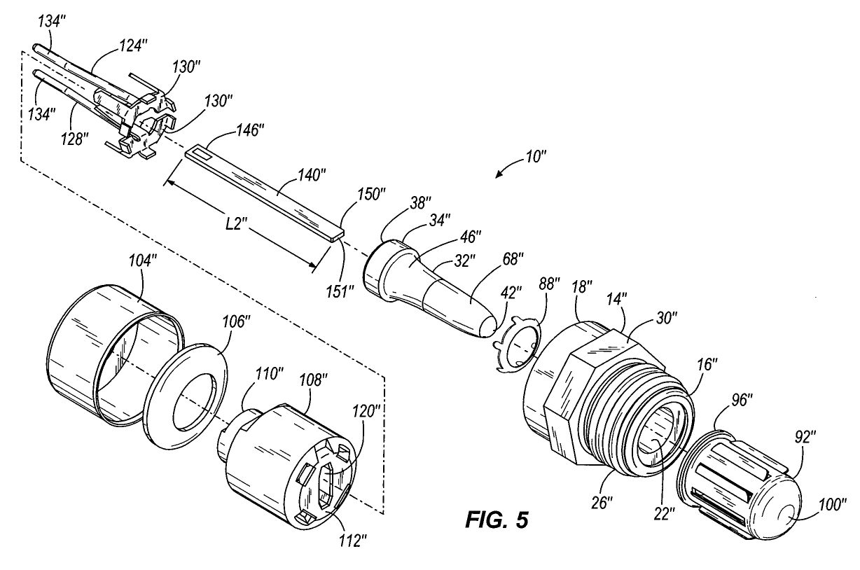

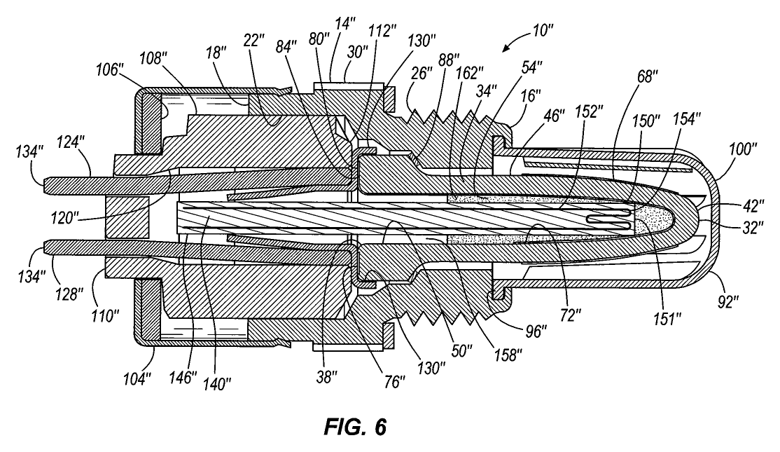

FIGS. 5 and 6 illustrate yet another construction of the exhaust gas sensor 10 of FIGS. 1-3. The exhaust gas sensor 10″ of FIGS. 5 and 6 is similar to the exhaust gas sensor 10 of FIGS. 1-3. Therefore, like components have been given the same reference number with the addition of a double prime symbol and only the differences between the exhaust gas sensor 10 of FIGS. 1-3 and the exhaust gas sensor 10″ of FIGS. 5 and 6 will be discussed in detail below.

Referring to FIG. 6, a heat conductive material 162″ is located within the cavity 54″ between the inner surface 50″ of the cup-shaped member 34″ and the heating element 140″. The material 162″ fills a portion of the air gap 158″ to directly couple or contact the heating element 140″ and the sensor element 32″. While the material 162″ has been described as directly coupling or contacting the heating element 140″ and the sensor element 32″, it should be understood that the heating element 140″ and/or the sensor element 32″ can include coatings, films, surface features, etc., and the material 162″ would still directly contact or directly couple the heating element 140″ and the sensor element 32″. The heat conductive material 162″ facilitates heat transfer from the heating element 140″ to the sensor element 32″. The material 162″ is also porous, between 2 percent and 80 percent porous in one construction, to allow the passage of reference air to the reference electrode 72″. The material 162″ also improves the heat distribution through the sensor element 32″, thereby reducing thermal stresses within the sensor element 32″. The material 162″ can be any suitable heat conductive material, such as alumina ceramic adhesive or other materials based on ceramic, glass, metal, or any mixture thereof. These materials can be in the form of adhesives, foams, solids, etc.

While the heating element 140″ of the sensor 10″ is a conventional ceramic planar heater, the heating element 140″ can also include conical or cylindrical heaters. In yet other constructions, the heating elements 140 and 140′ having the tapered or rounded end portions 150 and 150′, respectively, of FIGS. 1-4 can also be used in the sensor 10″ with the heat conductive material 162″.

Referring to FIGS. 5 and 6, to assemble the sensor 10″, the cavity 54″ is partially filled with the material 162″. Next, the heating element 140″ is inserted into the cavity 54″ as illustrated in FIG. 6. In one construction, the material 162″ is an adhesive and the material 162″ is viscous when the cavity 54″ is initially filled. Therefore, the material 162″ conforms to the inner surface 50″ of the cup-shaped member 34″ at the closed end 42″. Also, the material 162″ substantially surrounds the second end portion 150″ of the heating element 140″, including the distal end 151″, to directly couple the heating element 140″ and the sensor element 32″. Alternatively, in other methods of assembly, the heating element 140″ can be inserted into the cavity 54 before the cavity 54″ is filled with the material 162″.

With the heating element 140″ within the cavity 54″, the material 162″ hardens or cures from the viscous state to form the hardened porous heat conductive material 162″. The hardened material 162″ firmly holds the heating element 140″ in the position illustrated in FIG. 6. Accordingly, movement of the heating member 140″ is restricted and the heating element 140″ is less susceptible to damage from vibrations or movement of the sensor 10″.

As illustrated in FIG. 6, the cavity 54 is only partially filled with the material 162″ such that the air gap 158″ is maintained around a portion of the heating element 140″. In one construction that utilizes alumina ceramic adhesive for the porous heat conductive material 162″, the cavity 54 is partially filled with between about 0.1 grams to about 0.3 grams of the alumina ceramic adhesive that cures to form the porous heat conductive material 162″.

It should be understood that the invention has been described herein with reference to only one particular configuration of an exhaust gas sensor and the invention can be practiced in other sensor designs incorporating heaters and thimble-style sensor elements.

Various features and advantages of the invention are set forth in the following claims.

What is claimed is:

1. An exhaust gas sensor comprising:
a sensor element including,
a cup-shaped member having an outer surface and an inner surface defining a cavity,
an exhaust electrode coupled to the outer surface,
a reference electrode coupled to the inner surface,
a heating element located within the cavity; and
a heat conductive material within the cavity and between the inner surface of the cup-shaped member and the heating element to facilitate heat transfer from the heating element to the sensor element.

2. The exhaust gas sensor of claim 1, wherein the heat conductive material includes a material that hardens from a viscous state.

3. The exhaust gas sensor of claim 1, wherein the heat conductive material includes an adhesive.

4. The exhaust gas sensor of claim 3, wherein the heat conductive material includes an alumina ceramic adhesive.

5. The exhaust gas sensor of claim 1, wherein the heat conductive material is porous.

6. The exhaust gas sensor of claim 1, wherein the heat conductive material directly contacts the heating element and the sensor element.

7. The exhaust gas sensor of claim 1, further comprising an air gap within the cavity of the cup-shaped member and between the heating element and the inner surface of the cup-shaped member.

8. The exhaust gas sensor of claim 7, wherein the heat conductive material fills at least a portion of the air gap to directly couple the heating element and the sensor element.

9. The exhaust gas sensor of claim 7, wherein the cup-shaped member includes an open end and a closed end, wherein the heat conductive material is located within the cavity at the closed end.

10. The exhaust gas sensor of claim 1, wherein the heating element is a ceramic heating element.

11. The exhaust gas sensor of claim 10, wherein the heating element is a planar heating element.

12. The exhaust gas sensor of claim 10, wherein the heating element is a cylindrical heating element.

13. The exhaust gas sensor of claim 1, wherein the cup-shaped member is a ceramic cup-shaped member.

14. The exhaust gas sensor of claim 1, wherein the heat conductive material substantially conforms to the inner surface of the cup-shaped member.

15. The exhaust gas sensor of claim 1, wherein the cup-shaped member includes an open end and a closed end, wherein the heating element includes an end portion adjacent the closed end of the cup-shaped member, and wherein the heat conductive material surrounds substantially the entire end portion of the heating element.

16. A method of assembling an exhaust gas sensor, the method comprising:
providing a sensor element including a cup-shaped member having an outer surface and an inner surface defining a cavity, the sensor element further including an exhaust electrode coupled to the outer surface of the cup-shaped member and a reference electrode coupled to the inner surface of the cup-shaped member;
at least partially filling the cavity with a heat conductive material; and
inserting a heating element into the cavity.

17. The method of claim 16, wherein the heat conductive material is an adhesive, the method further comprising curing the adhesive to form a porous heat conductive material.

18. The method of claim 16, further comprising inserting the heating element into the cavity after at least partially filling the cavity with the heat conductive material.

19. The method of claim 16, further comprising inserting the heating element into the cavity before at least partially filling the cavity with the heat conductive material.

20. The method of claim 16, wherein the heat conductive material is viscous while at least partially filling the cavity, the method further comprising curing the material to form a hardened heat conductive material.
